(19) United States
(12) Patent Application Publication
(10) Pub. No.: US 2016/0212330 A1
(43) Pub. Date: Jul. 21, 2016

(54) IMAGE PROCESSING METHOD, IMAGE PROCESSING DEVICE, AND ELECTRONIC DEVICE

(71) Applicant: Lenovo (Beijing) Co., Ltd., Beijing (CN)

(72) Inventor: Fanzhi LI, Beijing (CN)

(73) Assignee: LENOVO (BEIJING) CO., LTD., Beijing (CN)

(21) Appl. No.: 14/812,574

(22) Filed: Jul. 29, 2015

(30) Foreign Application Priority Data
Jan. 20, 2015 (CN) 201510026751.5

(51) Int. Cl. H04N 5/232; G06T 5/00

(52) U.S. Cl. CPC H04N 5/23229; G06T 5/002; G06T 2207/10004

(57) ABSTRACT

An image processing method, an image processing device, and an electronic device are provided according to embodiments of the disclosure. The image processing method is applied to an electronic device including a lens and an image sensor. The image sensor is a flexible sensor configured to receive and image an image captured by the lens. The image processing method includes: acquiring imaging parameters of the lens capturing the image; acquiring, based on the imaging parameters of the lens capturing the image, lens distortion; and adjusting, based on the lens distortion, a curvature of the image sensor.

This application claims priority to Chinese Patent Application No. 201510026751.5, titled “IMAGE PROCESSING METHOD, IMAGE PROCESSING DEVICE, AND ELECTRONIC DEVICE”, filed with the Chinese State Intellectual Property Office on Jan. 20, 2015, which is incorporated by reference in its entirety herein.

### FIELD

The present disclosure relates to the field of image processing technology, and particularly to an image processing method, an image processing device, and an electronic device including the image processing device.

### BACKGROUND

Image processing includes various technical processing performed on various variations of an image signal so as to achieve higher image quality. Currently, various processing techniques for improving image quality include image de-noising, contrast enhancement, edge enhancement and so on, which help improving the image quality.

Imaging through a lens is necessary before image information is captured by an image sensor. Physically, since the lens include various simple lenses, it is difficult to ensure all the simple lenses focus on a same plane during operation of the lens, so that an image formed by shooting an object becomes curved, that is, distortion occurs. The larger a zoom multiplier of the lens is, the severer the image distortion is, as illustrated in FIG. 1.

### SUMMARY

An image processing method applied to an electronic device is provided. The image processing method includes: acquiring imaging parameters of a lens of the electronic device capturing an image; acquiring, based on the imaging parameters of the lens capturing the image, lens distortion; and adjusting, based on the lens distortion, a curvature of a flexible image sensor of the electronic device.

An image processing device applied to an electronic device is provided. The electronic device includes a lens and an image sensor. The image sensor is a flexible sensor configured to receive and image an image captured by the lens. The image processing device includes: a first acquiring module configured to acquire imaging parameters of the lens capturing the image; a second acquiring module configured to acquire, based on the imaging parameters of the lens capturing the image, lens distortion; and an adjusting module configured to adjust, based on the lens distortion, a curvature of the image sensor.

An electronic device is provided. The electronic device includes: a lens configured to capture an image; an image sensor being a flexible sensor configured to receive and image the image captured by the lens, and an image processing device configured to acquire imaging parameters of the lens capturing the image; acquire lens distortion of the lens; adjust, based on the lens distortion, a curvature of the image sensor.

### BRIEF DESCRIPTION OF THE DRAWINGS

FIG. 1 is a schematic diagram of deformation of an image taken in the related technology;

FIG. 2 is a flow chart of an image processing method according to an embodiment of the present disclosure; and

FIG. 3 is a schematic structural diagram of an image processing device according to an embodiment of the present disclosure.

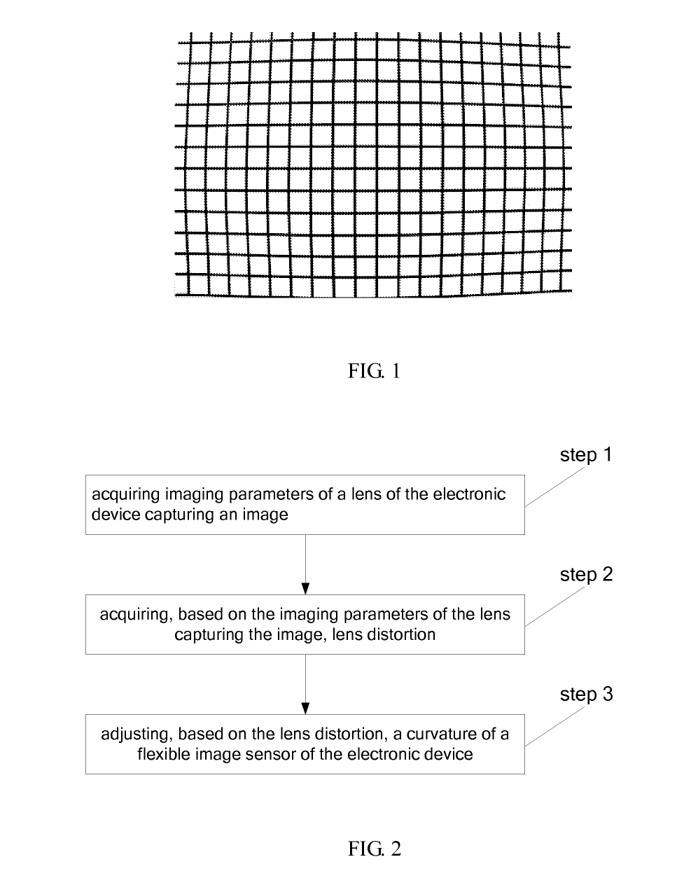

### DETAILED DESCRIPTION OF THE EMBODIMENTS

As described in the background, an image shot for an object in the related technology is curved. The larger a zoom multiplier of the lens for capturing the image is, the severer the image deformation is.

In view of this, an image processing method applied to an electronic device is provided according to an embodiment of the present disclosure. The image processing method includes:

acquiring imaging parameters of a lens of the electronic device capturing an image;

acquiring, based on the imaging parameters of the lens capturing the image, lens distortion; and

adjusting, based on the lens distortion, a curvature of a flexible image sensor of the electronic device.

According to the image processing method provided in the embodiment of the disclosure, when the method is applied to an electronic device for image shooting, lens distortion can be acquired based on imaging parameters of the lens capturing the image in the electronic device; based on the lens distortion, a curvature of the image sensor is adjusted. Thus, the image captured by the lens can be corrected, and image deformation can be reduced.

Accordingly, an image processing device applied to an electronic device is provided. The electronic device includes a lens and an image sensor. The image sensor is a flexible sensor configured to receive and image an image captured by the lens. The image processing device includes:

a first acquiring module, configured to acquire imaging parameters of the lens capturing the image;

a second acquiring module, configured to acquire, based on the imaging parameters of the lens capturing the image, lens distortion; and

an adjusting module, configured to adjust, based on the lens distortion, a curvature of the image sensor.

In addition, an electronic device is provided. The electronic device includes:

a lens, configured to capture an image;

an image sensor being a flexible sensor configured to receive and image the image captured by the lens, and

an image processing device, configured to acquire imaging parameters of the lens capturing the image; acquire lens distortion of the lens; adjust, based on the lens distortion, a curvature of the image sensor.

According to the image processing device or the electronic device, an image with higher quality and small deformation can be obtained.

For clarity of embodiments of the present disclosure, the embodiments of the present disclosure are illustrated in detail below in conjunction with drawings.

Details are provided in the following description for fully understanding of the present disclosure. However, the present disclosure can be implemented in other ways different from the embodiments provided here. Analogue may be obtained by those skilled in the art without deviating from the essence of the present disclosure. Therefore, the present disclosure is not limited to the particular embodiments provided below.

An image processing method applied to an electronic device is provided according to an embodiment of the disclosure. As shown in FIG. 2, the image processing method includes steps 1 to 3.

Step 1 includes: acquiring imaging parameters of a lens of the electronic device capturing an image. In an embodiment of the disclosure, the imaging parameters of the lens capturing an image include: a model of the lens, a focal length and a zoom range of the lens capturing the image. In other embodiments of the disclosure, the imaging parameters of the lens capturing the image may also include other parameters, which is not limited in the disclosure, as long as the model of the lens, the focal length and the zoom range of the lens capturing the image are included.

Step 2 includes: acquiring, based on the imaging parameters of the lens capturing the image, lens distortion.

In an embodiment of the disclosure, the acquiring, based on the imaging parameters of the lens capturing the image, lens distortion includes: acquiring lens distortion by querying, based on the imaging parameters of the lens, a database; where a correspondence between the imaging parameters and the lens distortion is stored in the database.

In another embodiment of the disclosure, the acquiring, based on the imaging parameters of the lens capturing the image, lens distortion includes: calculating lens distortion based on the imaging parameters of the lens. In other embodiments of the disclosure, other means may be adopted to acquire, based on the imaging parameters of the lens capturing the image, lens distortion, which is not limited in the disclosure.

It should be noted that lens distortion varies in a case that any one parameter of the imaging parameters of the lens capturing the image varies. For example, Amounts of the lens distortion are different for images captured by lenses having a same model, a same focal length, but different zoom ranges. Amounts of distortion of images captured by lenses having a same zoom range but different focal lengths are also different. Even amounts of the distortion of lenses having a same focal length, a same zoom range, but different models are also different.

Step 3 includes: adjusting, based on the lens distortion, a curvature of a flexible image sensor of the electronic device.

In an embodiment of the disclosure, the adjusting, based on the lens distortion, a curvature of a flexible image sensor of the electronic device, includes:

calculating, based on the lens distortion, an adjustment range of a preset position of an image capturing device; and

adjusting, based on the adjustment range of the preset position of the image capturing device, a curvature of a flexible image sensor of the electronic device.

It should be noted that, deformation of an image is severer at edge areas of the image. Therefore, in an embodiment of the disclosure, the preset position is four corners of the image sensor, which is not limited according the disclosure although. It can be determined as desired.

It should also be noted that, the more the preset positions are, the higher the precision of the adjustment on the curvature of the image sensor is. Then the image captured by the lens can be corrected, so that the image deformation can be reduced. In a case that multiple preset positions are included on the image sensor, the preset positions are evenly distributed on the image sensor.

In summary, if the image processing method provided according to embodiments of the disclosure is applied to an electronic device, lens distortion can be acquired based on the imaging parameters of the lens capturing the image; based on the lens distortion, a curvature of the image sensor can be adjusted. Thus, the image captured by the lens can be corrected, so that image deformation can be reduced.

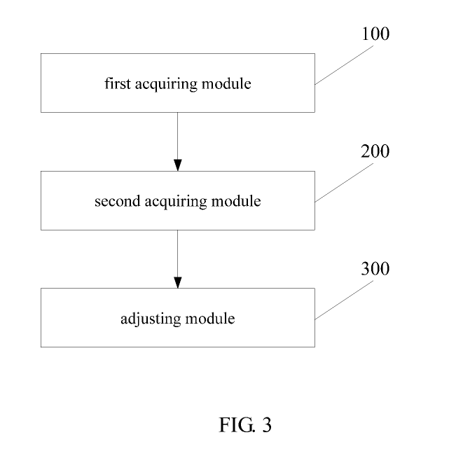

Accordingly, an image processing device applied to an electronic device is provided. The electronic device includes a lens and an image sensor. The image sensor is a flexible sensor configured to receive and image an image captured by the lens. As shown in FIG. 3, the image processing device includes: a first acquiring module 100, a second acquiring module 200, and an adjusting module 300.

The first acquiring module 100 is configured to acquire imaging parameters of the lens capturing the image.

The second acquiring module is configured to acquire, based on the imaging parameters of the lens capturing the image, lens distortion; and

The adjusting module is configured to adjust, based on the lens distortion, a curvature of the image sensor.

In an embodiment of the disclosure, the imaging parameters of the lens capturing the image include: a model of the lens, a focal length and a zoom range of the lens capturing the image. In other embodiments of the disclosure, the imaging parameters of the lens capturing the image may also include other parameters, which is not limited in the disclosure, as long as the model of the lens, the focal length and the zoom range of the lens capturing the image are included.

Based on any of the above embodiments, in an embodiment of the disclosure, the second acquiring module 200 includes: a querying module, configured to acquire lens distortion by querying, based on the imaging parameters of the lens, a database; where a correspondence between the imaging parameters and the lens distortion is stored in the database. In an embodiment of the disclosure, the second acquiring module 200 includes: a first calculating unit, configured to calculate lens distortion based on the imaging parameters of the lens, which is not limited in the disclosure and can be determined as desired.

Based on any of the above embodiments, in an embodiment of the disclosure, the adjusting module 300 includes:

a calculating unit, configured to calculate, based on the lens distortion, an adjustment range of a preset position of an image capturing device; and

an adjusting unit, configured to adjust a curvature of the image sensor based on the adjustment range of the preset position of the image capturing device.

It should be noted that, deformation of an image is severer at edge areas of the image. Therefore, in an embodiment of the disclosure, the preset position is four corners of the image sensor, which is not limited according the disclosure although. It can be determined as desired.

It should also be noted that, the more the preset positions are, the higher the precision of the adjustment on the curvature of the image sensor is. Then the image captured by the lens can be corrected, so that the image deformation can be reduced. In a case that multiple preset positions are included on the image sensor, the preset positions are evenly distributed on the image sensor.

In addition, an electronic device is provided. The electronic device includes:

a lens, configured to capture an image;

an image sensor being a flexible sensor configured to receive and image the image captured by the lens, and

an image processing device according to any of the above embodiments, configured to acquire imaging parameters of the lens capturing the image; acquire lens distortion of the lens; adjust, based on the lens distortion, a curvature of the image sensor.

Based on the above embodiment, in an embodiment of the disclosure, the electronic device further includes a database, where a correspondence between the imaging parameters of the lens capturing the image and the lens distortion is stored in the database. Thus, based on the imaging parameters of the lens capturing the image, the image processing device can obtain the lens distortion by querying the database.

In summary, the image processing device provided according to embodiments of the disclosure can acquire, based on the imaging parameters of the lens capturing the image, lens distortion; and then adjust, based on the lens distortion, a curvature of the image sensor. Thus the image captured by the lens can be corrected, so as to reduce image deformation. Thus an image in higher quality can be output by the image processing device or by an electronic device including the image processing device.

Parts of the specification are described in a progressive manner, with emphasis on differences between various parts. Hence, same or similar description of the various parts can refer to each other.

The above description of the embodiments enables those skilled in the art to implement or use the disclosure. Numerous modifications to these embodiments will be obvious to those skilled in the art. The general principle defined herein can be implemented in other embodiments without departing from the spirit or scope of the disclosure. Therefore, the disclosure will not be limited to these embodiments described herein, but in accordance with the widest scope consistent with the principle and novel features disclosed herein.

1. An image processing method applied to an electronic device, and the image processing method comprises:
acquiring imaging parameters of a lens of the electronic device capturing an image;
acquiring, based on the imaging parameters of the lens capturing the image, lens distortion; and
adjusting, based on the lens distortion, a curvature of a flexible image sensor of the electronic device.

2. The image processing method according to claim 1, wherein the imaging parameters of the lens capturing the image comprise: a model of the lens, a focal length and a zoom range of the lens capturing the image.

3. The image processing method according to claim 1, wherein the acquiring, based on the imaging parameters of the lens capturing the image, lens distortion, comprises:
acquiring lens distortion by querying, based on the imaging parameters of the lens, a database;
wherein a correspondence between the imaging parameters and the lens distortion is stored in the database.

4. The image processing method according to claim 1, wherein the adjusting, based on the lens distortion, a curvature of a flexible image sensor of the electronic device comprises:
calculating, based on the lens distortion, an adjustment range of a preset position of an image capturing device; and
adjusting, based on the adjustment range of the preset position of the image capturing device, a curvature of a flexible image sensor of the electronic device.

5. An image processing device applied to an electronic device, wherein the electronic device comprises a lens and an image sensor, the image sensor is a flexible sensor configured to receive and image an image captured by the lens, and the image processing device comprises:
a first acquiring module, configured to acquire imaging parameters of the lens capturing the image;
a second acquiring module, configured to acquire, based on the imaging parameters of the lens capturing the image, lens distortion; and
an adjusting module, configured to adjust, based on the lens distortion, a curvature of the image sensor.

6. The image processing device according to claim 5, wherein the imaging parameters of the lens capturing the image comprise: a model of the lens, a focal length and a zoom range of the lens capturing the image.

7. The image processing device according to claim 5, wherein the second acquiring module comprises:
a querying module, configured to acquire lens distortion by querying, based on the imaging parameters of the lens, a database;
wherein a correspondence between the imaging parameters and the lens distortion is stored in the database.

8. The image processing device according to claim 5, wherein the adjusting module comprises:
a calculating unit, configured to calculate, based on the lens distortion, an adjustment range of a preset position of an image capturing device; and
an adjusting unit, configured to adjust a curvature of the image sensor based on the adjustment range of the preset position of the image capturing device.

9. An electronic device comprising:
a lens, configured to capture an image;
an image sensor being a flexible sensor configured to receive and image the image captured by the lens, and
an image processing device, configured to acquire imaging parameters of the lens capturing the image; acquire lens distortion of the lens; adjust, based on the lens distortion, a curvature of the image sensor.

10. The electronic device according to claim 9, further comprising a database, wherein a correspondence between the imaging parameters of the lens capturing the image and the lens distortion is stored in the database.
